(19) United States
(12) Patent Application Publication
(10) Pub. No.: US 2005/0140208 A1
(43) Pub. Date: Jun. 30, 2005

(54) Brake system for idle stop vehicle

(76) Inventor: Sang Woo Ji, Whasung (KR)

Correspondence Address: MORGAN, LEWIS & BOCKIUS LLP (SF), 2 PALO ALTO SQUARE, PALO ALTO, CA, 94306, US

(21) Appl. No.: 11/009,976

(22) Filed: Dec. 10, 2004

(30) Foreign Application Priority Data
Dec. 24, 2003 (KR) 2003-0096595

(51) Int. Cl. B60T 8/32

(52) U.S. Cl. 303/192

(57) ABSTRACT

The brake system of an idle stop vehicle being provided with an integrated starter generator includes a starter motor, an electric power supply device for supplying an electric power to the starter motor, an air pump that is driven by the starter motor; a brake master cylinder booster that is connected to the air pump, a hydraulic unit for maintaining or releasing a hydraulic pressure of each wheel; and a controller. The air pump is driven by the starter motor to form a negative pressure in the master cylinder booster such that a hydraulic pressure of the hydraulic unit is maintained if an idle stop is released while the vehicle is located on an up-slope whose slope has a value that is higher than a first predetermined slope angle value or a down-slope whose slope has a value that is lower than a second predetermined slope value.

### CROSS REFERENCE TO RELATED APPLICATIONS

This application claims priority of Korean Application No. 10-2003-0096595, filed on Dec. 24, 2003, the disclosure of which is incorporated herein by reference.

### TECHNICAL FIELD OF THE INVENTION

The present invention relates to a brake system of a vehicle. More particularly, the invention relates to a brake system of an idle stop vehicle which prevents the vehicle from rolling down a slope by maintaining a negative pressure of a master cylinder booster for a predetermined time or by maintaining a pressure of a hydraulic unit by an engine or a brake control unit.

### BACKGROUND OF THE INVENTION

Generally, a 14V power system is used for current vehicles. It is known that a maximum power that the 14V power system can supply is about 2.5 kW. However, recently, various types of electric or electronic equipment have been installed in vehicles making it difficult for the 14V power system to provide stable electric power to such equipment. Therefore, research on power systems of 35V or 42V is widely being undertaken.

An idle stop function is adopted to a 42V vehicle in order to decrease air pollution and to decrease fuel consumption. The idle stop is a function in which an engine is turned off instead of idling when the vehicle is stopped while an acceleration pedal is in an off-state and a brake pedal is in an on-state.

More concretely, in the idle stop vehicle, if the acceleration pedal switch is in an off-state, the brake pedal switch is in an on-state, and the vehicle speed is 0 in a state in which an ignition switch is not operated, the engine is automatically stopped. Then, if the brake pedal switch is turned to an off-state and the idle stop is released, the engine is restarted by an integrated starter generator (ISG). However, if the idle stop is released when the vehicle is stopped on an up-slope or a down-slope, the vehicle rolls on the slope due to a shortage of driving force while the engine is being restarted.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

An embodiment of the present invention provides a brake system for maintaining a hydraulic pressure acting on wheels when an idle stop is released when a vehicle is on a slope. In one preferred embodiment of the present invention, a brake system of an idle stop vehicle is provided with an integrated starter generator. The brake system includes a starter motor for initial starting of the vehicle, an electric power supply device for supplying electric power to the starter motor, an air pump that is driven by the starter motor, a brake master cylinder booster that is connected to the air pump, a hydraulic unit for maintaining or releasing a hydraulic pressure of at least one wheel, and a controller for controlling at least one of the starter motor and the electric power supply device. The air pump is driven by the starter motor to form a negative pressure in the master cylinder booster such that a hydraulic pressure of the hydraulic unit is maintained if an idle stop is released while the vehicle is located on an up-slope whose slope angle value is higher than a first predetermined slope angle value or a down-slope whose slope angle value is lower than a second predetermined slope angle value.

In some embodiments, the brake system further includes a slope angle detection member that outputs a signal regarding a slope angle of a road on which the vehicle is located. The controller controls the electric power supply device and the starter motor based on the signal of the slope angle detection member.

In some embodiments, the controller is a microprocessor that is operated by a predetermined program. The predetermined program comprises instructions for determining whether the vehicle is in an idle stop state, determining whether an idle stop release condition exists if it is determined that the vehicle is in the idle stop state, determining a slope angle value of a road where the vehicle is located, and braking the vehicle if it is determined that the idle stop release conditions exists and if the slope angle value of the road where the vehicle is located is higher than a first predetermined slope angle value or lower than a second predetermined slope angle value. The braking may include driving the air pump by applying electric power to the starter motor, if it is determined that the idle stop condition exists and if the slope angle value of the road where the vehicle is located is higher than a first predetermined slope angle value or lower than a second predetermined slope angle value. The braking may also include maintaining a hydraulic pressure of the hydraulic unit for a predetermined time.

The program further may also include instructions for determining whether fuel injection has been started, and cutting off electric power supply to the starter motor, if it is determined that the fuel injection has been started.

In other embodiments of the present invention, a brake system of an idle stop vehicle having an integrated starter generator includes a slope angle detection member for detecting a slope angle value of a road where the vehicle is located, a hydraulic unit maintaining or releasing hydraulic pressure of at least one wheel, and a control unit for controlling the hydraulic unit. The control unit may be a microprocessor operated by a predetermined program which includes instructions for determining whether the vehicle is in an idle stop state, determining whether an idle stop release condition exists if it is determined that the vehicle is in the idle stop state, detecting a slope angle value of a road where the vehicle is located, and maintaining a hydraulic pressure of the hydraulic unit for a predetermined time, if it is determined that the idle stop conditions exists and if the slope angle value of the road where the vehicle is located is higher than the first predetermined slope angle value or lower than the second predetermined slope angle value.

The control unit may be an anti-lock brake system (ABS) control unit, which maintains a braking force by delaying operations of normally closed valves (NC valves) that are disposed at wheels for a predetermined time.

According to other embodiments of the invention, there is provided methods for performing the above-mentioned instructions.

### BRIEF DESCRIPTION OF THE DRAWINGS

The accompanying drawings, which are incorporated in and constitute a part of the specification, illustrate an embodiment of the invention, and, together with the description, serve to explain the principles of the invention, where:

FIG. 1 is a schematic block diagram of a brake system of an idle stop vehicle according to an embodiment of the present invention;

FIG. 2 is a flowchart showing operations of the brake system of the idle stop vehicle according to an embodiment of the present invention; and

FIG. 3 is a flowchart showing operations of the brake system of the idle stop vehicle according to another embodiment of the present invention.

### DETAILED DESCRIPTION OF THE PREFERRED EMBODIMENTS

Hereinafter, a preferred embodiment of the present invention will be described in detail with reference to the accompanying drawings.

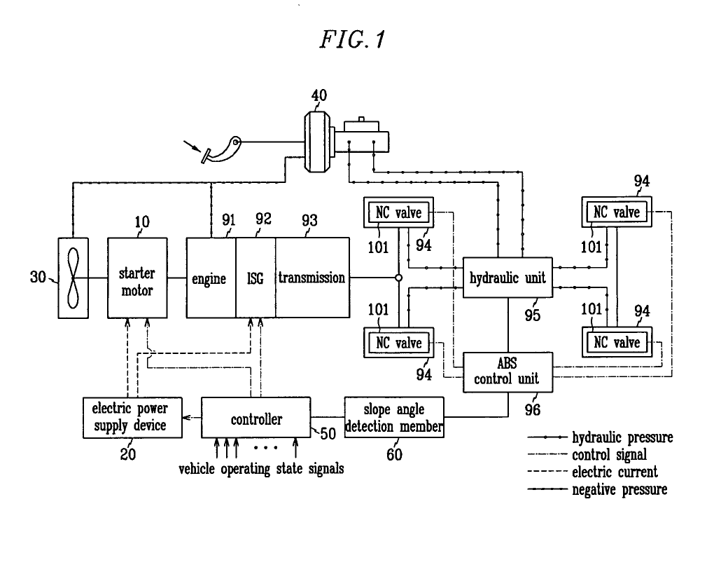

FIG. 1 is a schematic diagram of a brake system of an idle stop vehicle according to an embodiment of the present invention. As shown in FIG. 1, the brake system of the idle stop vehicle comprises a starter motor 10 for initial starting of the vehicle, an electric power supply device 20 supplying electric power to the starter motor 10, an air pump 30 that is coaxially connected to an output shaft of the starter motor 10 to be driven, a brake master cylinder booster 40 connected to the air pump 30, and a controller 50 controlling the starter motor 10 and the electric power supply device 20.

An integrated starter generator (ISG) 92 is disposed between an engine 91 and a transmission 93 such that the engine 91 and the transmission 93 are connected to each other therethrough in series. However, a belt-type integrated starter generator can also be used. The ISG 92 is connected to an output shaft of the engine 91 and to an input shaft of the transmission 93 so as to transmit a driving force from the engine 91 to the transmission 93, or the ISG 92 starts the engine 91 or generates an electric current when an idle stop is released.

In an idle stop vehicle, the starter motor 10 is connected to the engine 91 and performs initial starting of the vehicle. In some embodiments, the engine 91 is connected to the ISG 92, and power of the ISG 92 is transmitted to the transmission 93. The starter motor 10 is controlled by the controller (e.g., an ECU) 50, may be connected to a flywheel to start the engine 91. The starter motor 10 and the ISG 92 are connected to the electric power supply device 20 including at least one battery, so that an electric current is supplied to the ISG 92 and the starter motor 10.

The air pump 30 is disposed to one side of the starter motor 10, and the air pump 30 is driven by the starter motor 10. The air pump 30 and the engine 91 are each connected to a brake master cylinder booster 40, and they form a negative pressure in the master cylinder booster 40 to generate a braking force when a brake pedal is depressed by a driver.

The master cylinder booster 40 is connected to a hydraulic unit 95, and the hydraulic unit 95 distributes a hydraulic pressure to each wheel 94 so that the vehicle is braked. Therefore, a negative pressure is formed in the master cylinder booster 40 by the engine 91 when the engine 91 operates, and a negative pressure can still be formed in the master cylinder booster 40 by the air pump 30 driven by the starter motor 10 when the engine 91 does not operate.

In some embodiments, the controller 50 may be a microprocessor that is operated by a predetermined program. The idle stop state can be determined based on a signal of an engine control unit (ECU) or an engine control module (ECM), and if the controller 50 is formed integrally with the engine control unit or the engine control module, the controller 50 can determine the idle stop state by itself.

A slope angle detection member 60 outputs a signal regarding a slope angle of a road where the vehicle is located to the controller 50. The controller 50 calculates a slope angle value of the road based on the slope angle signal.

The predetermined program stored in the controller 50 can be a program for performing operations that will be stated hereinbelow. That is, the controller 50 is programmed to carry out instructions for performing a brake control method for an idle stop vehicle that will be explained hereinbelow.

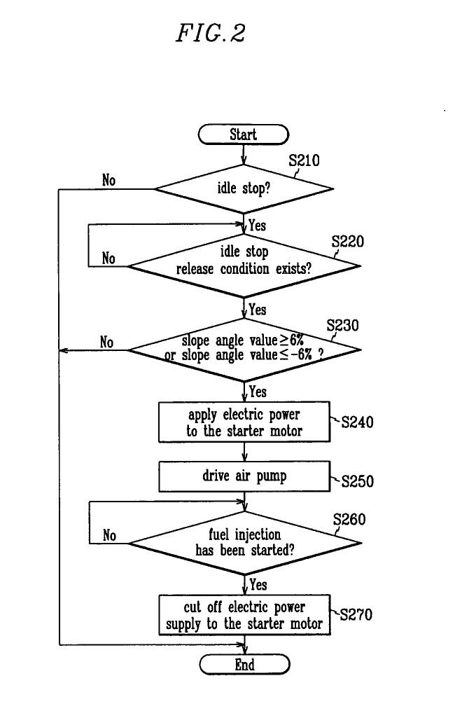

In FIG. 2, a flowchart for showing operations of the brake system of the idle stop vehicle according to an embodiment of the present invention is shown. As shown in FIG. 2, at step S210, it is determined whether a vehicle is currently in an idle stop state. If it is determined that the vehicle is in the idle stop state in step S210, it is determined whether an idle stop release condition exists at step S220.

The idle stop release condition can be determined based on vehicle state information indicating a driver's intention to drive the vehicle, such as releasing the brake pedal and depressing the acceleration pedal. This is obvious for an ordinarily person skilled in the art, so further explanation will be omitted.

If an idle stop state is released in the idle stop vehicle, electric power is supplied to the ISG so that the engine is restarted. At this time, a specific time period from an instant when the idle stop release condition starts to an initial combustion explosion of the engine must lapse. If the idle stop is released while the vehicle is located on an up-slope or a down-slope, the vehicle can roll during the specific time period. Therefore, in an embodiment of the present invention, in order to prevent the vehicle from rolling down slopes, a negative pressure in the master cylinder booster of a brake system is formed for a predetermined time period even when the brake pedal is released.

Concretely, if the idle stop release condition exists, and if the value of the slope angle of the vehicle is higher than a first predetermined slope angle value or lower than a second predetermined slope angle value at step S230, the pressure differential within the master cylinder booster will be developed. For example, the first predetermined slope angle value may be 6% and the second predetermined slope angle value may be −6%.

If the slope angle value of the vehicle is higher than the first predetermined slope angle value or lower than the second predetermined slope angle value, electric power of the electric power supply device 20 is applied to the starter motor 10, at step S240. The starter motor 10 is then driven by the electric power supplied from the electric power supply device 20, and the air pump 30 that is coaxially connected to the starter motor 10 is consequently driven at step S250.

If the air pump 30 is driven, a negative pressure is formed in the master cylinder booster 40 even when the brake pedal is released. Thus, a braking force can be maintained for a predetermined time period by delaying operations of NC valves (normally closed valves) 101 that are connected to the hydraulic unit 95 and are respectively provided at each wheel. Here, the hydraulic unit 95 may include an ABS (anti-lock brake system) control unit 96.

Then, at step S260 if it is determined that fuel injection has started, the electric power supply to the starter motor 10 is cut off so that operation of the air pump 30 stops.

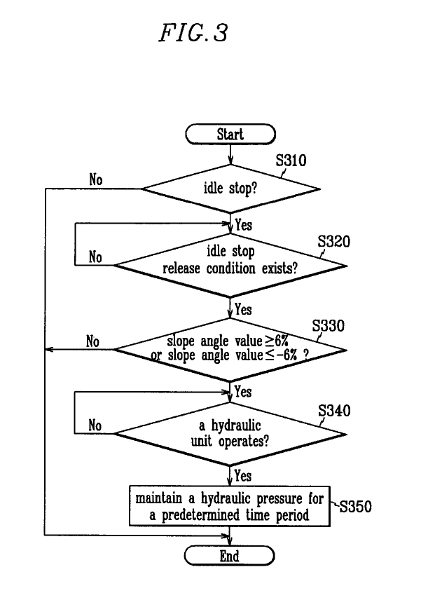

In FIG. 3, a flowchart for showing operations of the brake system of the idle stop vehicle according to another embodiment of the present invention is shown. The brake system of an idle stop vehicle according to another embodiment of the present invention comprises a slope angle detection member 60, a hydraulic unit 95 for maintaining or releasing hydraulic pressure acting on wheels 94, and a control unit 96 for controlling the hydraulic unit 95. As shown in FIG. 1, the control unit 96 can preferably be an ABS control unit.

At step S310, it is determined whether a vehicle is currently in an idle stop state. If it is determined that the vehicle is in the idle stop state at step S310, it is determined whether an idle stop release condition exists at step S320. The idle stop release condition can be determined as stated above.

In this embodiment, by maintaining a braking force by delaying operations of the NC valves 101 that are disposed in each wheel 94 for a predetermined time, the vehicle is prevented from rolling on an up-slope or down-slope when the idle stop is released. Concretely, if the idle stop release condition exists, and if a slope angle value of the vehicle (i.e., a value representing the slope of a road where the vehicle is located) is higher than a first predetermined slope angle value or is lower than a second predetermined slope angle value, at step S330, the vehicle may roll. For example, the first predetermined slope angle value may be 6% and the second predetermined slope angle value may be −6%.

If the slope angle value of the vehicle is higher than the first predetermined slope angle value or lower than the second predetermined slope angle value, it is determined whether the hydraulic unit 95 is operating at step S340. If it is determined that the hydraulic unit 95 is operating, at step S340, an operation of the hydraulic unit 95 is maintained for a predetermined time period at step S350. At this time, the hydraulic unit 95 is preferably controlled by the ABS control unit 96. For example, in order to maintain the braking force, the ABS control unit 96 delays operations of the NC valves 101 that are provided in the wheels 94 for a predetermined time period. In some embodiments, the predetermined time period is 0.7 seconds. Therefore, according to the brake system according to the embodiments of the present invention, even when the idle stop is released while a vehicle is located on a steep up-slope or on a steep down-slope, the vehicle can be prevented from rolling down the slope.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

1. A brake system of an idle stop vehicle being provided with an integrated starter generator, comprising:
a starter motor for initial starting of the vehicle;
an air pump that is driven by the starter motor;
a brake master cylinder booster that is connected to the air pump;
a hydraulic unit for maintaining or releasing hydraulic pressure of at least one wheel of the vehicle; and
a controller for controlling the starter motor,
wherein the air pump is driven by the starter motor to form a negative pressure in the master cylinder booster such that hydraulic pressure of the hydraulic unit is maintained if an idle stop is released while the vehicle is located on an up-slope whose slope has a value that is higher than a first predetermined slope angle value or a down-slope whose slope has a value that is lower than a second predetermined slope value.

2. The brake system of claim 1, further comprising an electric power supply device for supplying electric power to the starter motor, wherein the controller is configured to control the electric power supply device.

3. The brake system of claim 1, further comprising a slope angle detection member outputting a signal regarding a slope angle of a road on which the vehicle is located, wherein the controller controls provides control based on the signal of the slope angle detection member.

3. The brake system of claim 2, wherein the controller is a microprocessor and is operated by a predetermined program, and the predetermined program comprises instructions for:
determining whether the vehicle is in an idle stop state;
determining whether an idle stop release condition exists, if it is determined that the vehicle is in the idle stop state;
determining a slope angle value of a road where the vehicle is located; and
braking the vehicle, if it is determined that the idle stop release conditions exists and if the slope angle value of the road where the vehicle is located is higher than a first predetermined slope angle value or lower than a second predetermined slope angle value.

4. The brake system of claim 3, wherein said braking comprises driving the air pump by applying electric power to the starter motor, until fuel injection has been started.

5. The brake system of claim 4, wherein said braking further comprises:
determining whether fuel injection has been started; and
cutting off electric power supply to the starter motor, if it is determined that the fuel injection has been started.

6. The brake system of claim 3, wherein said braking comprises operating a hydraulic unit coupled to brakes of said vehicle, for a predetermined time period.

7. A brake system of an idle stop vehicle having an integrated starter generator, comprising:
a slope angle detection member for detecting a slope angle of a road where the vehicle is located,
a hydraulic unit for maintaining or releasing a hydraulic pressure of at least one wheel of the vehicle, and
a control unit for controlling the hydraulic unit,
wherein the control unit is a microprocessor operated by a predetermined program having instructions for:
determining whether the vehicle is in an idle stop state;
determining whether an idle stop release condition exists, if it is determined that the vehicle is in the idle stop state;
detecting a slope angle of a road where the vehicle is located; and
maintaining a hydraulic pressure of the hydraulic unit for a predetermined time, if it is determined that the idle stop conditions exists and if a value of the slope angle of the road where the vehicle is located is higher than the first predetermined slope angle value or lower than the second predetermined slope angle value.

8. The brake system of claim 7, wherein the control unit is an anti-lock brake system (ABS) control unit.

9. The brake system of claim 8, wherein the ABS control unit maintains a braking force by delaying operations of normally closed valves (NC valves) that are disposed at wheels for a predetermined time.

10. A method for braking an idle stop vehicle, comprising:
determining whether a vehicle is in an idle stop state;
determining whether an idle stop release condition exists, if it is determined that the vehicle is in the idle stop state;
determining a slope angle value of a road where the vehicle is located; and
braking the vehicle if it is determined that the idle stop release condition exists and if the slope angle value of the road where the vehicle is located is higher than a first predetermined slope angle value or lower than a second predetermined slope angle value.

11. The method of claim 10, wherein said braking comprises driving the air pump by applying electric power to the starter motor, until fuel injection has been started.

12. The method of claim 11, wherein said braking further comprises:
determining whether fuel injection has been started; and
cutting off electric power supply to a started motor, if it is determined that the fuel injection has started.

13. The method of claim 10, wherein said braking comprises operating a hydraulic unit coupled to brakes of said vehicle, for a predetermined time period.

14. A method for braking an idle stop vehicle, comprising:
determining whether the vehicle is in an idle stop state;
determining whether an idle stop release condition exists if it is determined that the vehicle is in the idle stop state;
detecting a slope angle of a road where the vehicle is located; and
maintaining a hydraulic pressure of a hydraulic unit for a predetermined time period, if it is determined that the idle stop conditions exists and if a value of the slope angle of the road where the vehicle is located is higher than the first predetermined slope angle value or lower than the second predetermined slope angle value.
